(19) United States
(12) Patent Application Publication
(10) Pub. No.: US 2020/0181292 A1
(43) Pub. Date: Jun. 11, 2020

(54) NOVEL WATER-SOLUBLE NATURAL POLYSACCHARIDE ANTIBACTERIAL MATERIAL AND PREPARATION METHOD THEREOF

(71) Applicant: TECHNICAL INSTITUTE OF PHYSICS AND CHEMISTRY OF THE CHINESE ACADEMY OF SCIENCES, Beijing (CN)

(72) Inventors: Zhongwei NIU, Beijing (CN); Shidong JIANG, Beijing (CN)

(73) Assignee: TECHNICAL INSTITUTE OF PHYSICS AND CHEMISTRY OF THE CHINESE ACADEMY OF SCIENCES, Beijing (CN)

(21) Appl. No.: 16/629,881

(22) PCT Filed: May 24, 2018
(86) PCT No.: PCT/CN2018/088173

§ 371 Date: Jan. 9, 2020

(30) Foreign Application Priority Data
Jul. 10, 2017 (CN) 201710556550.5

(51) Int. Cl. C08B 37/08; A01N 43/16

(52) U.S. Cl. CPC C08B 37/003; A01N 43/16

(57) ABSTRACT

Disclosed is a novel water-soluble natural polysaccharide antibacterial material. The molecules of the novel water-soluble natural polysaccharide antibacterial material not only contain guanidyl, but also contain amino acid groups, so that the biosafety of material is taken into consideration while the antibacterial performance of chitosan is improved, and the novel water-soluble natural polysaccharide antibacterial material has a low cytotoxicity and is a green antibacterial product. Also disclosed is a method for preparing the above-mentioned material, comprising the steps of: 1) dissolving chitosan in a diluted acid solution to obtain a diluted acid aqueous solution of chitosan; 2) adding cyanamide or dicyandiamide into the diluted acid aqueous solution of chitosan obtained in step 1) for reaction; 3) adding an amino acid activation solution into the reaction system in the step 2) for amidation; 4) adding hydroxylamine hydrochloride to terminate the reaction; and 5) filtering the reaction solution and then dialyzing the solution with deionized water, and performing microwave vacuum-drying to obtain the novel water-soluble natural polysaccharide antibacterial material. The method can be performed in a reaction kettle in a single-reaction manner, and the used primary raw materials are rich in sources and low in price, and are suitable for industrial production.

### TECHNICAL FIELD

The invention relates to the field of chitosan preparation, in particular to a novel water-soluble natural polysaccharide antibacterial material and preparation method thereof.

### BACKGROUND

Chitosan, whose chemical name is polyglucosamine (1-4)-2-amino-BD glucose, is a natural alkaline polysaccharide obtained by deacetylating chitin contained in shells of crustaceans such as shrimp and crab and fungal cell walls. Chitosan has excellent bioaffinity and biodegradability, and can be easily made into various derivatives. Because it has extremely abundant sources, and can be dissolved in hydrochloric acid, acetic acid and other organic acids, the chitosan has been widely used in industrial and medical fields. Because the chitosan has characteristics of biodegradability, biocompatibility, biological non-toxicity and antibacterial activity, chitosan has been made as one of the research hotspots in the development of natural antibacterial agents in recent years. However, because there are large number of hydrogen bonds in and between chitosan molecules, and chitosan has high crystallinity, is hardly soluble in water, and is only soluble in some diluted acid solutions, chitosan has lower antibacterial activity than traditional antibacterial agents, thereby greatly limiting the promotion and application of chitosan as an antibacterial agent.

In order to improve the water solubility of chitosan, various methods have been adopted. For example, water-soluble chitosan or water-soluble derivatives can be obtained by controlling the degree of deacetylation of chitosan between 50-60%, preparing chitosan into various inorganic or organic acid salts, and chemically modifying chitosan. Although these methods have solved the problem of water-solubility of chitosan, the antibacterial performance thereof has not been improved significantly. Chitosan molecules contain reactive hydroxyl and amino groups, other groups can be introduced into chitosan molecules by controlling reaction conditions with hydroxyl or amino groups to perform reactions such as acylation, carboxylation, etherification, NH₂ alkylation, esterification, hydrolysis, or the like [J. Adv. Drug. Deliv. Rev., 2001, 50, 591.1], so as to make a series of water-soluble chitosan derivatives, thereby changing physicochemical properties of chitosan and giving chitosan more specific functions to meet the needs of more fields to further expand the application scope of chitosan.

Guanidyl is the most positively-charged biologically active organic basic group currently found in nature, it can be protonated in physiological pH media and can form positively-charged groups under neutral, acidic, and basic conditions. Guanidine compounds are widely present in natural products, have strong solubility, and are strongly basic and electropositive. Guanidyl has biological activities such as anti-inflammatory, antihypertensive and hypolipidemic activities, antiviral activities, antitumor, etc., and also has strong alkalinity, strong stability, and good biological activity. The guanidyl compounds are easy to form hydrogen chains, so they have good antibacterial performance, and is widely used in medicine, agriculture, construction, clothing, chemical and other fields. Guanidyl is in a fully protonated state under normal conditions, and maintains an electropositive property [Wei Changmei, Synthesis of guanidine compounds and research on crystal structure thereof, PhD dissertation, 2004.]. Guanidyl can act on receptors and ligands through electrostatic interaction or hydrogen bonding, so the guanidyl can have good drug effects. Guanidyl compounds, as drugs, are mainly used as antihypertensive drugs, hypoglycemic drugs and antiviral drugs. The amino group of chitosan has higher reactive activity, so guanidination modification is performed for chitosan by means of amino groups to give chitosan similar properties to guanidyl compounds, thereby improving the antibacterial and antibacterial properties of chitosan. Hu et al. obtain guanidyl chitosan bisulfite by reacting thiourea trioxide with chitosan [Hu Y., et. al., Carbohyd. Polym., 2007, 67, 66.]. Sun et al. synthesize guanidinylated chitosan by using sodium tripolyphosphate as a cross-linking agent and polyhexamethyleneguanidine phosphate as a guanidinated reagent [Bioresour. Technol., 2010, 101, 5693.]. Zhai et al. obtain monoguanidine chitosan by reacting mononitrile ammonia, as a guanidinated reagent, with chitosan [Zhai X., et. al., J. Appl. Polym. Sci., 2011, 121, 3569.].

In addition, Xiao et al. also obtain guanidinated chitosan by using arginine as a guanidination reagent, and 1-(3-dimethylaminopropyl)-3-ethylcarbodiimide hydrochloride (EDC.HCl) and N-hydroxysuccinyl imine (NHS) as catalysts and allowing arginine to react with chitosan in 2-(N-morpholino) ethanesulfonic acid (MES) buffer solution at normal temperature [Xiao B., et. al., Carbohyd. Polym. 2011, 83, 144.]. Leucine, isoleucine, and lysine, similar to arginine, are all essential amino acids in the human body. The carboxyl groups contained in these three types of amino acids all have certain chemical activities, can react with the amino group on the chitosan molecule, and are suitable for functional modification of chitosan.

### SUMMARY OF THE INVENTION

The first object of the present invention is to provide a novel water-soluble natural polysaccharide antibacterial material.

The molecular structural formula of the natural polysaccharide antibacterial material is shown in Formula 1:

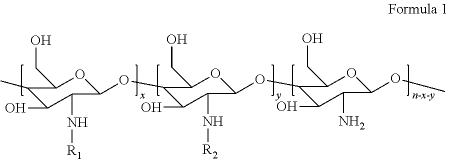

where R₁ is:

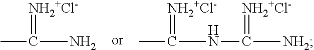

and

### R₂ is:

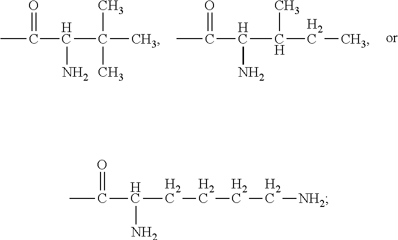

wherein x, y, and n are natural numbers, 0<x≤10⁷, 0<y≤10⁷, 10²≤n≤10⁷.

The novel water-soluble natural polysaccharide antibacterial material provided by the present invention contains both amino acids and guanidyl, improves the bacteriostatic effect and application range of the chitosan derivatives, and at the same time, compared with monoguanidine or biguanide hydrochloride derivatives of chitosan, reduces cytotoxicity and improves biological safety thereof.

Another object of the present invention is to provide a method for preparing the novel water-soluble natural polysaccharide antibacterial material.

To achieve the above object, the present invention adopts the following technical solution:

which include the following steps:
1) dissolving chitosan in a diluted acid solution to obtain a diluted acid aqueous solution of chitosan;
2) adding cyanamide or dicyandiamide into the diluted acid aqueous solution of chitosan obtained in step 1) for reaction:
3) adding an amino acid activation solution into the reaction system in the step 2) for amidation;
4) adding hydroxylamine hydrochloride to terminate the reaction; and
5) filtering the reaction solution and then dialyzing the solution with deionized water, and performing microwave vacuum-drying to obtain the novel water-soluble natural polysaccharide antibacterial material.

Preferably, the number average molecular weight of the chitosan in step 1) is 10²-10⁷, and the degree of deacetylation is 50-100%; preferably, the diluted acid is hydrochloric acid or acetic acid, and the acid concentration is 0-0.5 mol/L; the concentration of the diluted acid aqueous solution of the chitosan is 0.001-0.1 g/mL.

Preferably, the dissolving condition in step 1) is stirring at constant temperature between 60-110° C.

Preferably, the molar ratio of cyanamide or dicyandiamide to chitosan in step 2) is 0.5-5:1; and the reaction condition is stirring for 6-48 hours at constant temperature between 60-110° C.

Preferably, in step 3), the amino acid activation solution is obtained by the following method:

amino acids, N-hydroxysuccinimide and 1-(3-dimethylaminopropyl)-3-ethylcarbodiimide hydrochloride are dissolved in 2-(N-morpholino) ethanesulfonic acid buffer solution, and stirring is performed for activation at constant temperature between 0-35° C. for 0.5-3 hours; and
the concentration of the 2-(N-cyanamide morpholino) ethanesulfonic acid buffer solution is 30 mmol/L, and has the pH value of 5.0±0.5:
wherein the molar ratio of 1-(3-dimethylaminopropyl)-3-ethylcarbodiimide hydrochloride to amino acid is 0.5-5:1, and the molar ratio of N-hydroxysuccinimide to 1-(3-dimethylaminopropyl)-3-ethylcarbodiimide hydrochloride is 1:1.

Preferably, the amino acids are leucine, isoleucine or lysine.

Preferably, the molar ratio of chitosan to amino acids is 1-50:1; and the amidation reaction temperature in step 3) is 0-35° C.

Preferably, in step 5), during the dialysis by deionized water, the water is changed every 5-10 hours, and the water is changed for 6-8 times.

The beneficial effects of the present invention are as follows:

In the present invention, a new cellulose material never found before having flaky micromorphology is obtained by enabling cellulose powder and a solid high-molecule grinding material to be subjected to mechanical grinding. The flaky cellulose material has a function for blocking ultraviolet transmittance.

### DESCRIPTION OF THE DRAWINGS

The specific embodiments of the present invention are described in detail below in combination with the figures.

FIG. 1 is an infrared spectrum of the raw material chitosan and a novel water-soluble natural polysaccharide antibacterial material prepared in Example 1 of the present invention.

FIG. 2 is a result photograph of an antibacterial performance test against Staphylococcus aureus of the novel water-soluble natural polysaccharide antibacterial material prepared in Example 1 of the present invention, in which a pour plate method for detecting antibacterial performance against Staphylococcus aureus in GB15979-2002 “Hygienic standard for disposable sanitary products” is used.

FIG. 3 is a comparison test result of cytotoxicity, on ME3T3-E1 cells, of a novel water-soluble natural polysaccharide antibacterial material prepared in Example 1 of the present invention and a commercially available antibacterial material of quaternary ammonium salt chitosan derivative.

### DETAILED DESCRIPTION OF THE INVENTION

The present invention is described in detail below through examples. It should be noted that the examples are only used to further explain the present invention, and should not be construed as limitations on the protection scope of the present invention. Those skilled in the art can make some non-essential improvements and adjustments according to the summary of the invention.

The reaction described in the present invention is as follows:

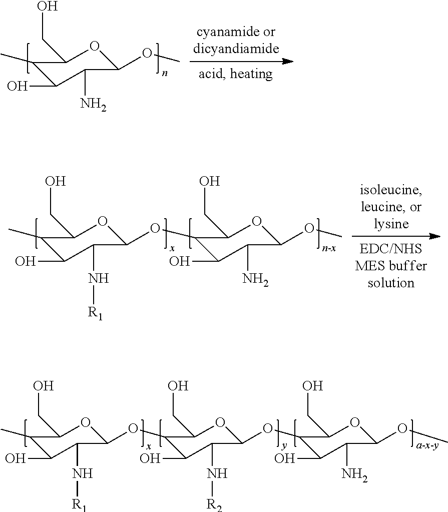

where R₁ is

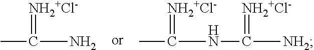

### R₂ is

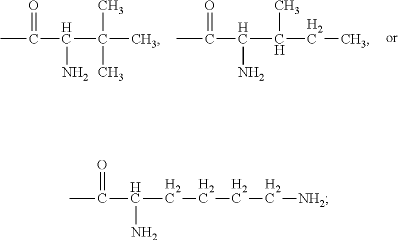

wherein x, y, and n are natural numbers, 0<x≤10⁷, 0<y≤10⁷, 10²≤n≤10⁷.

### Example 1

0.5 g chitosan was added to 100) ml 0.1 mol/L diluted hydrochloric acid, and was mechanically stirred for half an hour in an oil bath at 60° C., so that the chitosan was completely dissolved, so as to obtain a homogeneous solution with a chitosan concentration of 0.005 g/mL; the oil bath was heated to 110° C., 1.3 g dicyandiamide was added to the chitosan solution in one portion, the molar ratio of dicyandiamide to chitosan was 5:1, keeping constant temperature stirring for 6 hours; the reaction solution was cooled to room temperature, and then added with a 20 mL mixed solution activated at room temperature for 2 hours of lysine, N-hydroxysuccinimide (NHS), and 1-(3-dimethylaminopropyl)-3-ethylcarbodiimide hydrochloride (EDC.HCl) (the solvent was a 2-(N-morpholino) ethanesulfonic acid (MES) buffer solution at a concentration of 30 mmol/L with a pH value of about 5.0), the reaction was performed with continuous stirring at room temperature for 24 hours, wherein the molar ratio of chitosan, lysine, NHS, and EDC was 5:1:2:2: the reaction solution was filtered and loaded into a dialysis bag, the two ends of the dialysis were tied tightly, the bag was placed in deionized water for dialysis, the water was changed every four hours, after the water was changed for eight times, and the dialysate was placed in a microwave vacuum dryer for treatment, thereby obtaining the novel water-soluble antibacterial material.

FIG. 1 shows an infrared spectrum of the raw material chitosan and a novel water-soluble natural polysaccharide antibacterial material prepared in Example 1 of the present invention. It can be seen by comparing the two spectral lines (the black spectral line is for the raw material chitosan, and the red spectral line is for the novel water-soluble natural polysaccharide antibacterial material), the wide peak at 3438 cm⁻¹ of the raw material corresponded to the stretching vibration of —NH₂ and —OH, and the peak positions at this place are red-shifted and widened after modification. The broadening of the peak at this position also shows that these —NH₂ and —OH have intra- and inter-molecular hydrogen bonds with different strengths. The difference in peak widths reflects the strength of the hydrogen bonds. The peak position of the modified chitosan spectrum is red-shifted and widened, meaning that hydrogen bonds disappear, indicating that the derivatization reaction of chitosan has occurred; at the same time, —NH₂ bending vibration originally appeared at 1597 cm⁻¹ for the chitason disappears, while the peaks appearing at 1659 cm⁻¹ and 1553 cm⁻¹ on the spectrum for modified chitosan are attributed to the stretching vibration peak of C═N and the bending vibration peak of N—H, respectively. These changes in the two spectra lines fully demonstrate that the modified functional groups are successfully grafted to the molecular chain of chitosan through the amino group.

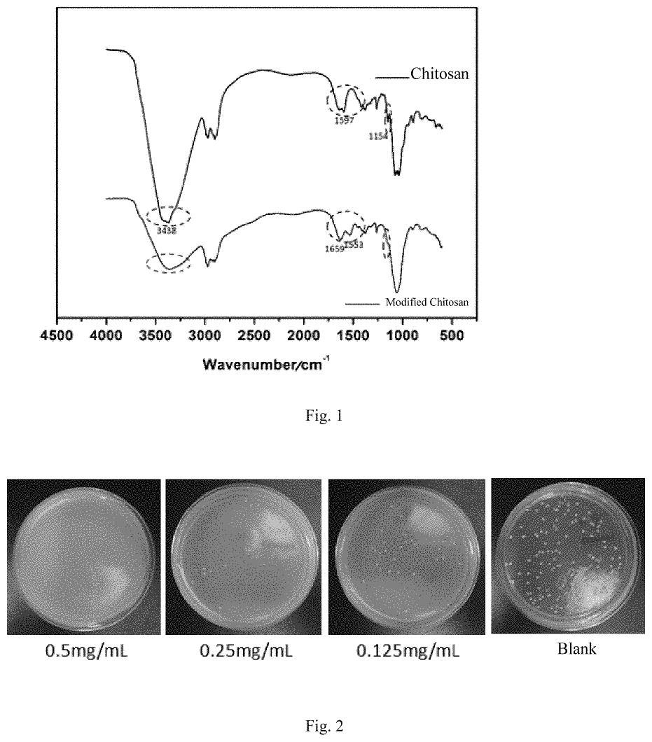

FIG. 2 is a result photograph of an antibacterial performance test against Staphylococcus aureus of the novel water-soluble natural polysaccharide antibacterial material prepared in Example 1 of the present invention, in which a pour plate method for detecting antibacterial performance against Staphylococcus aureus in GB15979-2002 “Hygienic standard for disposable sanitary products” is used, from left to right, there are antibacterial test results for the culture medium with the novel water-soluble natural polysaccharide antibacterial materials (dissolved in neutral deionized water) prepared in this example with a concentration of 0.5 mg/mL, 0.25 mg/mL and 0.125 mg/mL respectively and a blank control group (without adding any antibacterial agent) after the medium being cultured for 36 hours in a 37° C. constant temperature and humidity incubator. The results show that the novel water-soluble natural polysaccharide antibacterial material prepared in this example has good inhibition performance against Staphylococcus aureus.

The statistical data result for the antibacterial rate of Staphylococcus aureus detected by using the pour plate method on the product prepared in this example is as follows:

TABLE 1
Antibacterial performance test result of novel
water-soluble natural polysaccharide antibacterial
material against staphylococcus aureus

| | | | | | Blank |
|---|---|---|---|---|---|
| | Serial | Concentration of Di-Modified Chitosan | | | Control |
| | No. of | in Medium (mg/ml) | | | Group |
| | Medium | 0.5 | 0.25 | 0.125 | 0 |
| Number of | 1 | 1 | 10 | 31 | 104 |
| Colonies | 2 | 0 | 5 | 45 | 109 |
| on Culture | 3 | 0 | 8 | 38 | 103 |
| Medium | average | 0 | 8 | 38 | 105 |

| | | | | |
|---|---|---|---|---|
| Antibacterial Rate | 100% | 92.4% | 63.8% | 0 |

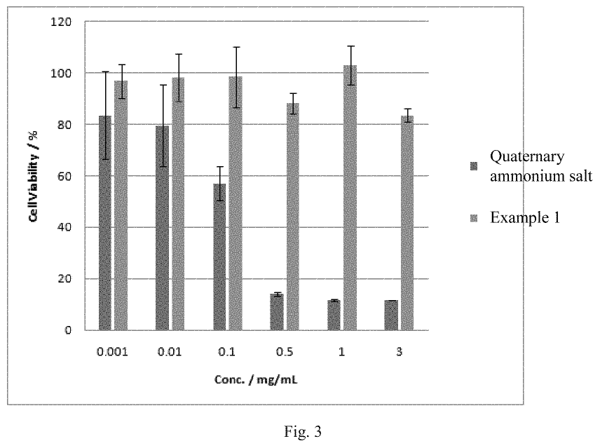

FIG. 3 is a comparison test result of cytotoxicity, on ME3T3-E1 cells, of a novel water-soluble natural polysaccharide antibacterial material prepared in Example 1 of the present invention and a commercially available antibacterial material of quaternary ammonium salt chitosan derivative. The data test results show that the novel water-soluble natural polysaccharide antibacterial material has less cytotoxicity, and the cytotoxicity is significantly less than the commercially available antibacterial material of quaternary ammonium salt chitosan derivative.

The results of the above data show that the novel water-soluble natural polysaccharide antibacterial material not only has good antibacterial performance, but also can lead to normal cell growth under effective bacteriostatic concentrations, having good biological safety.

### Example 2

1.0 g chitosan was added to 100 ml diluted hydrochloric acid with a concentration of 0.1 mol/L, and mechanically stirred for one hour in an oil bath at 60° C. so that the chitosan was completely dissolved to obtain a homogeneous solution with a chitosan concentration of 0.01 g/mL; the oil bath was heated to 105° C., 1.05 g cyanamide was added to the chitosan solution system in one portion, and the molar ratio of cyanamide to chitosan was 4:1, keeping stirring for 6 hours at constant temperature; then the reaction solution on the oil bath was cooled to room temperature, and was added with 20 ml mixed solution activated in a mixed ice-water bath for 3 hours of leucine, N-hydroxysuccinimide (NHS) and 1-(3-dimethylaminopropyl)-3-ethyl carbodiimide hydrochloride (EDC.HCl) (the solvent was a 30 mmol/L 2-(N-morpholino) ethanesulfonic acid (MES) buffer solution), reaction was continued with stirring for 10 hours at room temperature, wherein the molar ratio of chitosan, leucine, NHS, and EDC was 50:1:5:5; the reaction solution was filtered and loaded into a dialysis bag, the two ends of the dialysis bag were tied tightly, the bag was put into deionized water for dialysis, the water was changed once every four hours, the dialysat was placed into a microwave vacuum dryer after changing the water for eight times, thereby obtaining the novel soluble natural polysaccharide antibacterial material.

### Example 3

2.0 g chitosan was added to 100 ml diluted hydrochloric acid with a concentration of 0.15 mol/L, and mechanically stirred for one hour in an oil bath at 60° C. so that the chitosan was completely dissolved to obtain a homogeneous solution with a chitosan concentration of 0.02 g/mL; the oil bath was heated to 100° C., 2.08 g dicyanamide was added to the chitosan solution system in one portion, and the molar ratio of dicyanamide to chitosan was 2:1, keeping stirring for 12 hours at constant temperature of 100° C.; then the reaction solution on the oil bath was cooled to room temperature, and was added with 20 ml mixed solution activated in a mixed ice-water bath for 3 hours of isoleucine, N-hydroxysuccinimide (NHS) and 1-(3-dimethylaminopropyl)-3-ethyl carbodiimide hydrochloride (EDC.HCl) (the solvent was a 30 mmol/L 2-(N-morpholino) ethanesulfonic acid (MES) buffer solution with a pH value of about 5), reaction was continued with stirring for 24 hours at room temperature, wherein the molar ratio of chitosan, isoleucine, NHS, and EDC was 20:1:4:4; the reaction solution was filtered and loaded into a dialysis bag, the two ends of the dialysis bag were tied tightly, the bag was put into deionized water for dialysis, the water was changed once every four hours, the dialysat was placed into a microwave vacuum dryer after changing the water for eight times, thereby obtaining the novel soluble natural polysaccharide antibacterial material.

### Example 4

5.0 g chitosan was added to 100 ml diluted hydrochloric acid with a concentration of 0.15 mol/L, and mechanically stirred for one hour in an oil bath at 60° C., so that the chitosan was completely dissolved to obtain a homogeneous solution with a chitosan concentration of 0.05 g/mL; the oil bath was heated to 80° C., 3.91 g cyanamide was added to the chitosan aqueous solution system in one portion, and the molar ratio of cyanamide to chitosan was 3:1, keeping reaction for 24 hours at 80° C.; then the reaction solution on the oil bath was cooled to room temperature, and was added with 20 ml mixed solution activated at room temperature for 2 hours of lysine, N-hydroxysuccinimide (NHS) and 1-(3-dimethylaminopropyl)-3-ethyl carbodiimide hydrochloride (EDC.HCl) (the solvent was a 30 mmol/L 2-(N-morpholino) ethanesulfonic acid (MES) buffer solution with a pH value of about 5), reaction was continued with stirring for 24 hours at room temperature, wherein the molar ratio of chitosan, lysine, NHS, and EDC was 5:1:2:2; the reaction solution was filtered and loaded into a dialysis bag, the two ends of the dialysis bag were tied tightly, the bag was put into deionized water for dialysis, the water was changed once every four hours, the dialysat was placed into a microwave vacuum dryer after changing the water for eight times, thereby obtaining the novel soluble natural polysaccharide antibacterial material.

### Example 5

7.0 g chitosan was added to 100 ml diluted hydrochloric acid with a concentration of 0.3 mol/L, and mechanically stirred for two hours in an oil bath at 70° C., so that the chitosan was completely dissolved to obtain a homogeneous solution with a chitosan concentration of 0.07 g/mL; under the condition where the oil bath was 70° C., 1.83 g cyanamide was added to the chitosan aqueous solution system in one portion, and the molar ratio of cyanamide to chitosan was 1:1, keeping for 36 hours at constant temperature; then the reaction solution on the oil bath was cooled to room temperature, and was added with 20 ml mixed solution activated at room temperature for 2 hours of leucine, N-hydroxysuccinimide (NHS) and 1-(3-dimethylaminopropyl)-3-ethyl carbodiimide hydrochloride (EDC.HCl) (the solvent was a 30 mmol/L 2-(N-morpholino) ethanesulfonic acid (MES) buffer solution with a pH value of about 5), reaction was continued with stirring for 24 hours at room temperature, wherein the molar ratio of chitosan, leucine, NHS, and EDC was 5:1:4:4; the reaction solution was filtered and loaded into a dialysis bag, the two ends of the dialysis bag were tied tightly, the bag was put into deionized water for dialysis, the water was changed once every four hours, the dialysat was placed into a microwave vacuum dryer after changing the water for eight times, thereby obtaining the novel soluble natural polysaccharide antibacterial material.

### Example 6

10.0 g chitosan was added to 100 ml diluted hydrochloric acid with a concentration of 0.5 mol/L, and mechanically stirred for two hours in an oil bath at 60° C., so that the chitosan was completely dissolved to obtain a homogeneous solution with a chitosan concentration of 0.1 g/mL; under the condition where the oil bath was 60° C., 2.61 g dicyanamide was added to the chitosan aqueous solution system in one portion, and the molar ratio of dicyanamide to chitosan was 0.5:1, keeping reaction for 48 hours at 60° C.; then the reaction solution on the oil bath was cooled to room temperature, and was added with 30 ml mixed solution activated at room temperature for 2 hours of isoleucine, N-hydroxysuccinimide (NHS) and 1-(3-dimethylaminopropyl)-3-ethyl carbodiimide hydrochloride (EDC.HCl) (the solvent was a 30 mmol/L 2-(N-morpholino) ethanesulfonic acid (MES) buffer solution with a pH value of about 5), reaction was continued with stirring for 24 hours at 35° C., wherein the molar ratio of chitosan, isoleucine, NHS, and EDC was 4:1:3:3; the reaction solution was filtered and loaded into a dialysis bag, the two ends of the dialysis bag were tied tightly, the bag was put into deionized water for dialysis, the water was changed once every four hours, the dialysat was placed into a microwave vacuum dryer after changing the water for eight times, thereby obtaining the novel soluble natural polysaccharide antibacterial material.

Obviously, the foregoing examples of the present invention are merely examples for clearly explaining the present invention, and are not limitations for the embodiments of the present invention. For those of ordinary skill in the art, based on the above description, other different forms of changes or modifications can be made, and all embodiments cannot be exhaustive herein. Any obvious changes or modifications derived from the technical solutions of the present invention are still within the protection scope of the present invention.

1. A novel water-soluble natural polysaccharide antibacterial material, wherein the molecular structural formula of the natural polysaccharide antibacterial material is shown in Formula 1: 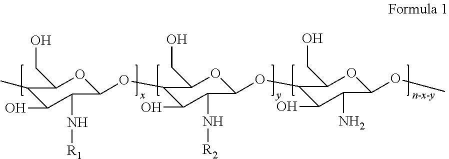
where R₁ is: 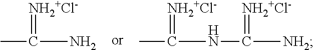
and
R₂ is: 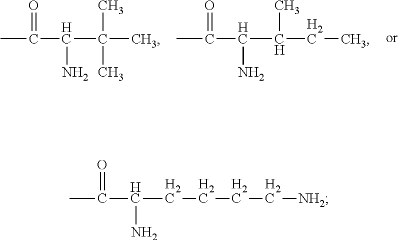
wherein x, y, and n are natural numbers, 0<x≤10⁷, 0<y≤10⁷, 10²≤n≤10⁷.

2. A method for preparing the novel water-soluble natural polysaccharide antibacterial material according to claim 1, comprising the steps of:
1) dissolving chitosan in a diluted acid solution to obtain a diluted acid aqueous solution of chitosan;
2) adding cyanamide or dicyandiamide into the diluted acid aqueous solution of chitosan obtained in step 1) for reaction;
3) adding an amino acid activation solution into the reaction system in the step 2) for amidation;
4) adding hydroxylamine hydrochloride to terminate the reaction; and
5) filtering the reaction solution and then dialyzing the solution with deionized water, and performing microwave vacuum-drying to obtain the novel water-soluble natural polysaccharide antibacterial material.

3. The method according to claim 2, wherein in step 1), the chitosan has a number average molecular weight of 10²-10⁷ and a degree of deacetylation of 50-100%;
the diluted acid is hydrochloric acid or acetic acid, and has a concentration of 0-0.5 mol/L; and
the concentration of the diluted acid aqueous solution of chitosan is 0.001-0.1 g/mL.

4. The method according to claim 2, wherein the dissolving condition in step 1) is stirring at constant temperature between 60-110° C.

5. The method according to claim 2, wherein in step 2), the molar ratio of cyanamide or dicyandiamide to chitosan is 0.5-5:1; and
the reaction condition is stirring for 6-48 hours at constant temperature between 60-110° C.

6. The method according to claim 2, wherein in step 3), the amino acid activation solution is obtained by the following method:
dissolving amino acids, N-hydroxysuccinimide and 1-(3-dimethylaminopropyl)-3-ethylcarbodiimide hydrochloride in 2-(N-morpholino) ethanesulfonic acid buffer solution, and performing stirring at constant temperature between 0-35° C. for activation for 0.5-3 hours;
wherein the concentration of the 2-(N-morpholino) ethanesulfonic acid buffer solution is 30 mmol/L, and has a pH value of 5.0±0.5.

7. The method according to claim 6, wherein the molar ratio of the 1-(3-dimethylaminopropyl)-3-ethylcarbodiimide hydrochloride to the amino acid is 0.5-5:1, and the molar ratio of N-hydroxysuccinimide to 1-(3-dimethylaminopropyl)-3-ethylcarbodiimide hydrochloride is 1:1.

8. The method according to claim 2, wherein the amino acids are leucine, isoleucine or lysine.

9. The method according to claim 2, wherein the molar ratio of the chitosan to the amino acid is 1-50:1; and
in step 3), the amidation reaction temperature is 0-35° C.

10. The method according to claim 2, wherein in step 5), the deionized water is changed every 5-10 hours for 6-8 times during the dialysis process by deionized water.

11. The method according to claim 3, wherein the amino acids are leucine, isoleucine or lysine.

12. The method according to claim 4, wherein the amino acids are leucine, isoleucine or lysine.

13. The method according to claim 5, wherein the amino acids are leucine, isoleucine or lysine.

14. The method according to claim 6, wherein the amino acids are leucine, isoleucine or lysine.

15. The method according to claim 7, wherein the amino acids are leucine, isoleucine or lysine.
